(19) United States
(12) Patent Application Publication
(10) Pub. No.: US 2024/0151321 A1
(43) Pub. Date: May 9, 2024

(54) SOLENOID VALVE AND ASSEMBLING METHOD THEREFOR

(71) Applicant: HL MANDO CORPORATION, Pyeongtaek-si (KR)

(72) Inventor: Wonjun LEE, Yongin-si (KR)

(73) Assignee: HL MANDO CORPORATION, Pyeongtaek-si (KR)

(21) Appl. No.: 18/229,856

(22) Filed: Aug. 3, 2023

(30) Foreign Application Priority Data
Nov. 7, 2022 (KR) 10-2022-0147080

(51) Int. Cl. F16K 31/06

(52) U.S. Cl. CPC F16K 31/0675

(57) ABSTRACT

Disclosed herein are a solenoid valve and assembling method therefor in which the solenoid valve includes a solenoid coil around which a coil is wound in a cylindrical shape and a housing configured to surround an outer side of the solenoid coil and a bobbin disposed above the solenoid coil and a lower case disposed below the solenoid coil and an inner case provided in a cylindrical shape so that the solenoid coil is wound therearound, disposed inside the solenoid coil and in contact with the lower case.

### CROSS-REFERENCE TO RELATED APPLICATION

This application claims the benefit of Korean Patent Application No. 10-2022-0147080, filed on Nov. 7, 2022 in the Korean Intellectual Property Office, the disclosure of which is incorporated herein by reference.

### BACKGROUND

### 1. Field

Embodiments of the present disclosure relate to a solenoid valve, and more particularly, to a solenoid valve device that may effectively dissipate heat generated by a solenoid coil, and an assembling method therefor.

### 2. Description of the Related Art

Brake systems are essential components of vehicles for braking. In recent years, various electronically controlled brake systems have been proposed, and examples thereof include an anti-lock brake system (ABS), an electro-hydraulic brake (EHB) system, an electronic stability control (ESC) system, and the like.

The electronically controlled brake system includes a plurality of solenoid valves for adjusting a braking hydraulic pressure transferred to a wheel brake. The solenoid valve is an electronic valve using a solenoid coil and electricity, and as the demand for the electronically controlled brake system increases, the demand for the solenoid valve also increases.

In a solenoid valve according to the related art, a coil is directly wound on a lower end of a hollow bobbin to form a solenoid coil, and an outer case surrounds the solenoid coil. In this case, when a current flows through the solenoid coil, heat is generated in the coil, and the generated heat is directly conducted to the bobbin, is then conducted to a case provided in a lower portion thereof or radiated to the air provided thereinside, and is thus dissipated.

However, the solenoid coil of the solenoid valve is made of copper having high thermal conductivity while the bobbin on which the coil is directly wound is made of a plastic having low thermal conductivity. Thus, cooling efficiency of the solenoid coil is low, and the bobbin is also deformed and carbonized.

Accordingly, a solenoid valve device has been required in which the heat generated by the coil may be effectively dissipated, and at the same time, damage to internal components due to the heat generated by the solenoid coil may be minimized.

### RELATED ART DOCUMENT

### Patent Document

Korean Patent Application Publication No. 10-2022-0093478 (published on Jul. 5, 2022).

### SUMMARY

Therefore, it is an aspect of the present disclosure to provide a solenoid valve having improved heat dissipation performance.

It is another aspect of the present disclosure to provide a solenoid valve having improved heat dissipation performance by directly conducting heat generated by a solenoid coil to an inner case having high thermal conductivity.

It is still another aspect of the present disclosure to provide a solenoid valve in which heat generated by a solenoid coil is not directly conducted to a bobbin having low thermal conductivity, and thus the bobbin is prevented from being deformed and carbonized.

Additional aspects of the disclosure will be set forth in part in the description which follows and, in part, will be obvious from the description, or may be learned by practice of the disclosure.

In accordance with one aspect of the present disclosure, a solenoid valve includes a solenoid coil around which a coil is wound in a cylindrical shape, a housing configured to surround an outer side of the solenoid coil, a bobbin disposed above the solenoid coil, a lower case disposed below the solenoid coil, and an inner case provided in a cylindrical shape so that the solenoid coil is wound therearound, disposed inside the solenoid coil, and being in contact with the lower case.

The inner case may be formed integrally with the lower case.

The lower case and the inner case may be formed of iron.

The lower case may be provided in a hollow disc shape, and the inner case may be provided in a hollow cylindrical shape.

The solenoid valve may further include a hydraulic adjustment device in contact with a lower end of the lower case.

The solenoid valve may further include a lead wire coupled to the bobbin and formed long in an axial direction.

The bobbin may include a bobbin body provided in a hollow disc shape and a bobbin protrusion connected to the bobbin body and protruding upward.

The solenoid valve may further include a lead wire accommodated in the bobbin protrusion and formed long in an axial direction.

The housing may include a housing side surface disposed close to a side surface of the solenoid valve, and a housing upper part configured to cover an upper side of the solenoid valve.

The bobbin may include a bobbin body provided in a hollow disc shape, and a bobbin protrusion connected to the bobbin body, protruding upward, coupled to the bobbin, and configure to accommodate a lead wire formed long in an axial direction, and the housing upper part may include an opening so that the bobbin protrusion passes therethrough.

The inner case may be provided in a hollow cylindrical shape, and the housing upper part may include a hollow cylindrical shape to communicate with the hollow cylindrical shape of the inner case.

A hollow inner circumferential surface of the inner case and a hollow outer circumferential surface of the housing upper part may be in contact with each other so that the housing upper part fixes the inner case.

The lower case may be provided in a hollow disc shape, the housing side surface may be provided in a hollow cylindrical shape, and a hollow inner circumferential surface of the housing side surface and a disc-shaped outer circumferential surface of the lower case may be in contact with each other so that the housing side part fixes the lower case.

The lead wire may be provided as a plurality of lead wires.

The hydraulic adjustment device may be formed of aluminum.

In accordance with another aspect of the present disclosure, a method of assembling a solenoid valve including a solenoid coil includes coupling an inner case disposed inside the solenoid coil and provided in a cylindrical shape and a lower case disposed below the solenoid coil, making the solenoid coil by winding a coil around an outer circumferential surface of the inner case, coupling a bobbin to an upper portion of the inner case, and coupling a housing to surround an outer side of the solenoid coil.

The method may further include coupling a hydraulic adjustment device to a lower end of the lower case.

The method may further include coupling a lead wire formed long in an axial direction to the bobbin.

The coupling of the housing to surround the outer side of the solenoid coil may include allowing a bobbin protrusion to pass through an opening when the bobbin includes a bobbin body provided in a hollow disc shape and the bobbin protrusion connected to the bobbin body and protruding upward, the housing includes a housing side surface configured to surround a side surface of the solenoid valve and a housing upper part configured to cover an upper side of the solenoid valve, and the housing upper part includes the opening so that the bobbin protrusion passes therethrough.

The coupling of the housing to surround the outer side of the solenoid coil may include allowing a hollow outer circumferential surface of the housing upper part to be in contact with a hollow inner circumferential surface of the inner case and allowing a disc-shaped outer circumferential surface of the lower case to be in contact with a hollow inner circumferential surface of the housing side surface when the hollow inner circumferential surface of the inner case is in contact with the hollow outer circumferential surface of the housing upper part, the lower case is provided in a hollow disc shape, the housing side surface is provided in a hollow cylindrical shape, and the hollow inner circumferential surface of the housing side surface is in contact with the disc-shaped outer circumferential surface of the lower case.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view illustrating a state in which a solenoid coil is directly wound around a bobbin in a solenoid valve according to a related art;

FIG. 2 is a cross-sectional view illustrating a solenoid coil is directly wound around an inner case in a solenoid valve according to an embodiment of the present disclosure;

FIG. 3 is a perspective view illustrating a state in which respective components are disassembled in the solenoid valve according to the related art; and

FIG. 4 is a perspective view illustrating a state in which respective components are disassembled in the solenoid valve according to the embodiment of the present disclosure.

### DETAILED DESCRIPTION

Hereinafter, present embodiments will be described in detail with reference to the accompanying drawings. The following embodiments are presented to sufficiently transfer the spirit of the present disclosure to those skilled in the art to which the present disclosure pertains. The present disclosure is not limited to the embodiments presented herein and may be embodied in other forms. In the drawings, illustration of components irrelevant to the description will be omitted to clarify the present disclosure, and the sizes of the components may be slightly exaggerated to help understanding.

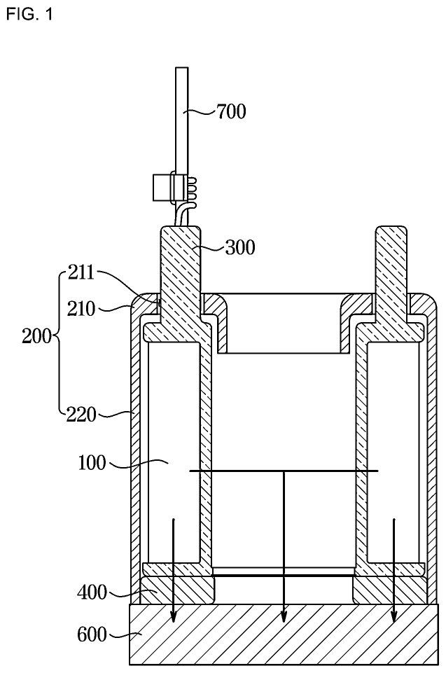

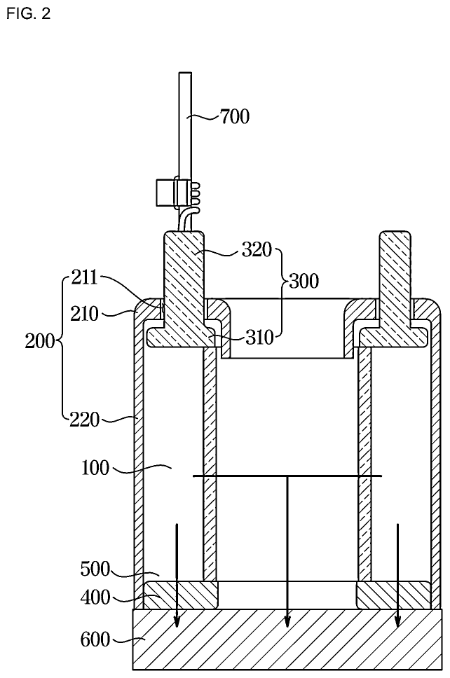

FIG. 1 is a cross-sectional view illustrating a state in which a solenoid coil 100 is directly wound around a bobbin 300 in a solenoid valve according to a related art, and FIG. 2 is a cross-sectional view illustrating a solenoid coil 100 is directly wound around an inner case 500 in a solenoid valve according to an embodiment of the present disclosure.

Referring to FIGS. 1 and 2, the solenoid valve according to the related art includes the solenoid coil 100, and the bobbin 300, the inner case, a lower case 400, and a housing 200 provided around the solenoid coil 100. The solenoid valve according to the related art may additionally include a hydraulic adjustment device 600 and a lead wire 700. In contrast, the solenoid valve according to an embodiment of the present disclosure differs from the solenoid valve according to the related art in terms of the shape and arrangement of the bobbin 300, the inner case 500, and the lower case 400.

In the solenoid coil 100, a coil is wound in a cylindrical shape. The coil generates a magnetic field when electricity flows therethrough and has magnetism, and through this principle, electrical energy is converted into magnetic energy to move internal components such as a plunger. In this case, the electrical energy is also converted into thermal energy, and the solenoid coil 100 serves as a heat source configured to generate heat.

The solenoid valve should dissipate the heat generated from the solenoid coil 100. In the related art, the heat of the coil is conducted through the bobbin 300 around which the solenoid coil 100 is directly wound, and the heat of the bobbin 300 is then radiated into the air accommodated inside the solenoid valve or conducted to the lower case 400 in contact with the bobbin 300. However, since the bobbin 300 made of plastic has low thermal conductivity, a cooling effect of the solenoid coil 100 is low, and the bobbin 300 may be deformed or carbonized due to a high temperature. Accordingly, in the embodiment of the present disclosure, the solenoid coil 100 is directly wound around the inner case 500 having high thermal conductivity rather than the bobbin 300 having low thermal conductivity.

The bobbin 300 is disposed above the solenoid coil 100. The bobbin 300 may be provided with a bobbin body 310 provided in a hollow disc shape and disposed at an upper end of the solenoid coil 100 and a bobbin protrusion 320 connected to the bobbin body 310 and protruding upward. In the solenoid valve according to the related art, a lower end of the bobbin 300 is provided so that the solenoid coil 100 is directly wound around the bobbin 300, but in the solenoid valve according to the present embodiment, since the solenoid coil 100 is not directly wound around the bobbin 300, there is no separate lower end.

The housing 200 is provided to surround an outside of the solenoid coil 100. The housing 200 may include a housing side surface 210 disposed close to a side surface of the solenoid valve and a housing upper part 220 for covering an upper side of the solenoid valve. The housing upper part 220 may include an opening 211 so that the bobbin protrusion 320 may pass therethrough.

The lower case 400 is disposed below the solenoid coil 100. The lower case 400 may be made of a material having high thermal conductivity, and particularly, may be formed of iron. As in the embodiment of the present disclosure in FIG. 2, the lower case 400 may be provided in a hollow disc shape and in direct contact with a lower end of the solenoid coil 100. Further, the lower case 400 may be provided to be in direct contact with a lower end of the inner case 500 bent to surround the lower end of the solenoid coil 100, and the lower case 400 and the inner case 500 may be integrally formed.

The inner case 500 is provided in a cylindrical shape so that the solenoid coil 100 is wound therearound, is disposed inside the solenoid coil 100, and is in contact with the lower case 400. Like the lower case 400, the inner case 500 may be made of a material having high thermal conductivity, and particularly, may be formed of iron. Thus, unlike the solenoid valve according to the related art in which the solenoid coil 100 is directly wound around the bobbin 300 made of a plastic, the solenoid coil 100 is directly wound around the inner case 500 having high thermal conductivity and thus transfers heat to the inner case 500. The heat transferred to the inner case 500 may be dissipated by being transferred to the lower case 400 or being radiated through the air accommodated inside the inner case 500 provided in a hollow cylindrical shape.

The housing upper part 220 may include a hollow cylindrical shape to communicate with the hollow cylindrical shape of the inner case 500 so that the air accommodated inside the inner case 500 circulates to increase heat dissipation efficiency.

The housing 200 serves to fix the inner case 500 and the lower case 400, and in detail, the housing upper part 220 may be provided so that a hollow inner circumferential surface of the inner case 500 and a hollow outer circumferential surface of the housing upper part 220 are in contact with each other to fix the inner case 500. The housing side surface 210 may be provided so that a hollow inner circumferential surface of the housing side surface 210 and an outer circumferential surface of the disc of the lower case 400 are in contact with each other to fix the lower case 400.

The hydraulic adjustment device 600 may be included to be in contact with a lower end of the lower case 400 and may be formed of aluminum having high thermal conductivity.

The lead wire 700 may be coupled to the bobbin 300 and formed long in an axial direction. The lead wire 700 may be accommodated in the bobbin protrusion 320 and formed long in the axial direction, and the lead wire 700 may be provided as a plurality of lead wires 700.

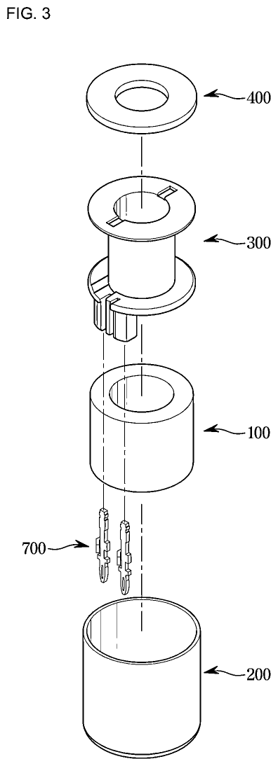

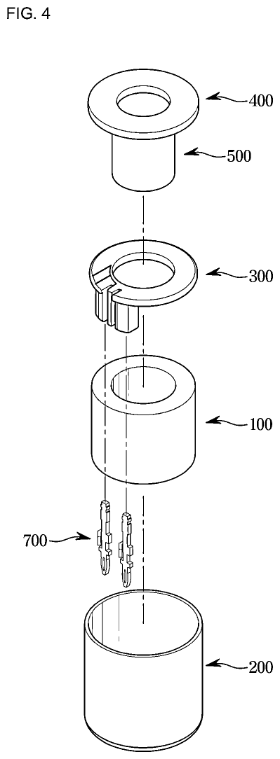

FIG. 3 is a perspective view illustrating a state in which respective components are disassembled in the solenoid valve according to the related art, and FIG. 4 is a perspective view illustrating a state in which respective components are disassembled in the solenoid valve according to the embodiment of the present disclosure.

Hereinafter, a method of assembling the solenoid valve will be described.

Referring to FIGS. 3 and 4, the method of assembling the solenoid valve including the solenoid coil 100 includes coupling the inner case 500 disposed inside the solenoid coil 100 and provided in the cylindrical shape and the lower case 400 disposed below the solenoid coil 100, making the solenoid coil 100 by winding the coil around an outer circumferential surface of the inner case 500, coupling the bobbin 300 to an upper portion of the inner case 500, and coupling the housing 200 to surround the outside of the solenoid coil 100.

The method of assembling the solenoid valve according to the embodiment of the present disclosure differs from a method of assembling the solenoid valve according to the related art in terms of the coupling of the inner case 500 and the lower case 400 and the making of the solenoid coil 100 by winding the coil around the outer circumferential surface of the inner case 500 rather than the lower end of the bobbin 300. However, when the inner case 500 and the lower case 400 are integrally provided, the coupling of both components may be omitted.

The method further includes coupling the lead wire 700 formed long in the axial direction to the bobbin 300 when the lead wire 700 is included in the solenoid coil 100 and coupling the hydraulic adjustment device 600 to the lower end of the lower case 400 when the hydraulic adjustment device 600 is included in the solenoid coil 100.

In this case, as described above, when the bobbin 300 includes the bobbin body 310 and the bobbin protrusion 320, the housing 200 includes the housing side surface 210 and the housing upper part 220, and the housing upper part 220 includes the opening 211, the coupling of the housing 200 to surround the outside of the solenoid coil 100 may include allowing the bobbin protrusion 320 to pass through the opening 211.

Further, when a hollow inner circumferential surface of the inner case 500 may be in contact with the hollow outer circumferential surface of the housing upper part 220, the lower case 400 is provided in a hollow disc shape, the housing side surface 210 is provided in a hollow cylindrical shape, and the hollow inner circumferential surface of the housing side surface 210 may be in contact with the outer circumferential surface of the disc of the lower case 400, the coupling of the housing 200 to surround the outside of the solenoid coil 100 may include allowing the hollow circumferential surface of the housing upper part 220 to be in contact with the hollow inner surface of the inner case 500 and allowing the outer circumferential surface of the disc of the lower case 400 to be in contact with the hollow inner surface of the housing side surface 210.

Through the solenoid valve device and the assembling method having the above-described configuration according to the present embodiment, the solenoid coil 100 serving as a heat source is wound around the inner case 500 instead of the lower end of the bobbin 300, and accordingly, the heat generated by the solenoid coil 100 is directly transferred to the inner case 500 having high thermal conductivity. Thus, heat dissipation performance of the solenoid valve can be improved, and the bobbin 300 can be prevented from being deformed and carbonized. Thus, it is apparent that durability of the solenoid valve is improved and marketability is increased.

As is apparent from the above description, an aspect of the present embodiment provides a solenoid valve having improved heat dissipation performance.

Another aspect of the present embodiment provides a solenoid valve having improved heat dissipation performance by directly conducting heat generated by a solenoid coil to an inner case having high thermal conductivity.

Still another aspect of the present embodiment provides a solenoid valve in which heat generated by a solenoid coil is not directly conducted to a bobbin having low thermal conductivity, and thus the bobbin is prevented from being deformed and carbonized.

What is claimed is:

1. A solenoid valve comprising:
a solenoid coil around which a coil is wound in a cylindrical shape;
a housing configured to surround an outer side of the solenoid coil;
a bobbin disposed above the solenoid coil;
a lower case disposed below the solenoid coil; and
an inner case provided in a cylindrical shape so that the solenoid coil is wound therearound, disposed inside the solenoid coil, and in contact with the lower case.

2. The solenoid valve of claim 1, wherein the inner case is formed integrally with the lower case.

3. The solenoid valve of claim 1, wherein the lower case and the inner case are formed of iron.

4. The solenoid valve of claim 1, wherein the lower case is provided in a hollow disc shape, and
the inner case is provided in a hollow cylindrical shape.

5. The solenoid valve of claim 1, further comprising:
a hydraulic adjustment device configured to be in contact with a lower end of the lower case.

6. The solenoid valve of claim 1, further comprising:
a lead wire coupled to the bobbin and formed long in an axial direction.

7. The solenoid valve of claim 1, wherein the bobbin includes:
a bobbin body provided in a hollow disc shape; and
a bobbin protrusion connected to the bobbin body and protruding upward.

8. The solenoid valve of claim 7, further comprising:
a lead wire accommodated in the bobbin protrusion and formed long in an axial direction.

9. The solenoid valve of claim 1, wherein the housing includes:
a housing side surface disposed close to a side surface of the solenoid valve; and
a housing upper part configured to cover an upper side of the solenoid valve.

10. The solenoid valve of claim 9, wherein the bobbin includes:
a bobbin body provided in a hollow disc shape; and
a bobbin protrusion connected to the bobbin body, protruding upward, coupled to the bobbin, and configured to accommodate a lead wire formed long in an axial direction, and
the housing upper part includes an opening so that the bobbin protrusion passes therethrough.

11. The solenoid valve of claim 9, wherein the inner case is provided in a hollow cylindrical shape, and
the housing upper part includes a hollow cylindrical shape to communicate with the hollow cylindrical shape of the inner case.

12. The solenoid valve of claim 11, wherein a hollow inner circumferential surface of the inner case and a hollow outer circumferential surface of the housing upper part are in contact with each other so that the housing upper part fixes the inner case.

13. The solenoid valve of claim 9, wherein the lower case is provided in a hollow disc shape,
the housing side surface is provided in a hollow cylindrical shape, and
a hollow inner circumferential surface of the housing side surface and a disc-shaped outer circumferential surface of the lower case are in contact with each other so that the housing side part fixes the lower case.

14. The solenoid valve of claim 6, wherein the lead wire is provided as a plurality of lead wires.

15. The solenoid valve of claim 5, wherein the hydraulic adjustment device is formed of aluminum.

16. A method of assembling a solenoid valve including a solenoid coil, the method comprising:
coupling an inner case disposed inside the solenoid coil and provided in a cylindrical shape and a lower case disposed below the solenoid coil;
making the solenoid coil by winding a coil around an outer circumferential surface of the inner case;
coupling a bobbin to an upper portion of the inner case; and
coupling a housing to surround an outer side of the solenoid coil.

17. The method of claim 16, further comprising:
coupling a hydraulic adjustment device to a lower end of the lower case.

18. The method of claim 16, further comprising:
coupling a lead wire formed long in an axial direction to the bobbin.

19. The method of claim 16, wherein the coupling of the housing to surround the outer side of the solenoid coil includes allowing a bobbin protrusion to pass through an opening when the bobbin includes a bobbin body provided in a hollow disc shape and the bobbin protrusion connected to the bobbin body and protruding upward, the housing includes a housing side surface configured to surround a side surface of the solenoid valve and a housing upper part configured to cover an upper side of the solenoid valve, and the housing upper part includes the opening so that the bobbin protrusion passes therethrough.

20. The method of claim 19, wherein the coupling of the housing to surround the outer side of the solenoid coil includes allowing a hollow outer circumferential surface of the housing upper part to be in contact with a hollow inner circumferential surface of the inner case and allowing a disc-shaped outer circumferential surface of the lower case to be in contact with a hollow inner circumferential surface of the housing side surface when the hollow inner circumferential surface of the inner case is in contact with the hollow outer circumferential surface of the housing upper part, the lower case is provided in a hollow disc shape, the housing side surface is provided in a hollow cylindrical shape, and the hollow inner circumferential surface of the housing side surface is in contact with the disc-shaped outer circumferential surface of the lower case.
